(19) United States
(12) Patent Application Publication
(10) Pub. No.: US 2009/0094101 A1
(43) Pub. Date: Apr. 9, 2009

(54) QUICK TO COACH: A Performance Management Tool

(75) Inventor: Pamela Bezona, Bothell, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(73) Assignee: Performance eSource, Inc. d/b/a Performance eSource, Bothell, WA (US)

(21) Appl. No.: 11/869,057

(22) Filed: Oct. 9, 2007

(51) Int. Cl. G06Q 10/00; G06F 17/40; G06F 19/00

(52) U.S. Cl. 705/11

(57) ABSTRACT

The current invention is a human capital performance management tool which creates measurable performance expectations for correcting ineffective behavior. The tool provides managers a “what to say and how to say it” coaching conversation and documentation to address behaviors specific to individual employee performances.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

Prior art in this area is limited to the quantification of worker output. However, prior art does not address the more difficult problem of human capital behavior. An object of the present invention is to provide a method and apparatus to help human resource managers and other individuals who manage employees, volunteers, contractors or other human capital, discuss and move towards correcting problem behaviors exhibited by said human capital.

Most managers have little to no formal human resources performance management training and consequently, do not have the observational skills or appropriate language to articulate and move towards changing or correcting problem behaviors exhibited by human capital. The current invention provides managers, at any level, with a method to identify and articulate problem behaviors so that there is movement towards resolving root cause issues. Additionally, the current invention provides managers a script and the appropriate documentation to describe ineffective behaviors.

Another object of the current invention is to provide managers with quantifiable performance expectations. Human capital may receive input such as “listen actively” or “be a team player”. However, these terms do not outline measurable, objective expectations. The quantifiable performance expectation outlined in the current invention can give guidance to the manager and the human capital to determine whether, once put on notice, said human capital are responding to input from the manager.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an example screen shot of the menu of operation available at the computer interface;

FIG. 2 is a flow chart of the selectable option “Create Coaching” in the menu of FIG. 1;

FIG. 3 is an example screen shot of the step one shown in FIG. 2 (Select Human Capital);

FIG. 4 is an example screen shot of sub-part A of Step 2 shown in FIG. 2 (Competency Category);

FIG. 5 is an example screen shot of competencies that may be listed when the user browses problem behaviors;

FIG. 6 is an example screen shot of sub-part B of Step 2 shown in FIG. 2 (Performance Issues);

FIG. 7 is an example screen shot of sub-part C of Step 2 shown is FIG. 2 (Problem Behaviors);

FIG. 8 is an example screen shot of sub-part A of Step 3 shown in FIG. 2 (State the Issue);

FIG. 9 is an example screen shot of sub-part B of Step 3 shown in FIG. 2 (State Why Problem);

FIG. 10 is an example screen shot of sub-part A of Step 3 shown in FIG. 2 (State Expectations);

FIG. 11 is an example screen shot of sub-part B of Step 4 shown in FIG. 2 (State Expectation Examples);

FIG. 12 is an example screen shot of sub-part C of Step 4 shown in FIG. 2 (Human Capital Accountability);

FIG. 13 is an example screen shot of feedback that is generated by the current invention.

### DETAILED DESCRIPTION OF THE INVENTION

The purpose of the current invention is to provide managers of human capital a method and apparatus to identify and describe problem behavior exhibited by said human capital. The current invention also provides managers with a script to communicate problem behaviors that are, for example, observed, observed and experienced, or experienced, among others, so that managers can effectively communicate with human capital. The current invention also helps managers quantify performance expectations.

The present invention has been implemented as a software program running on a general purpose computer.

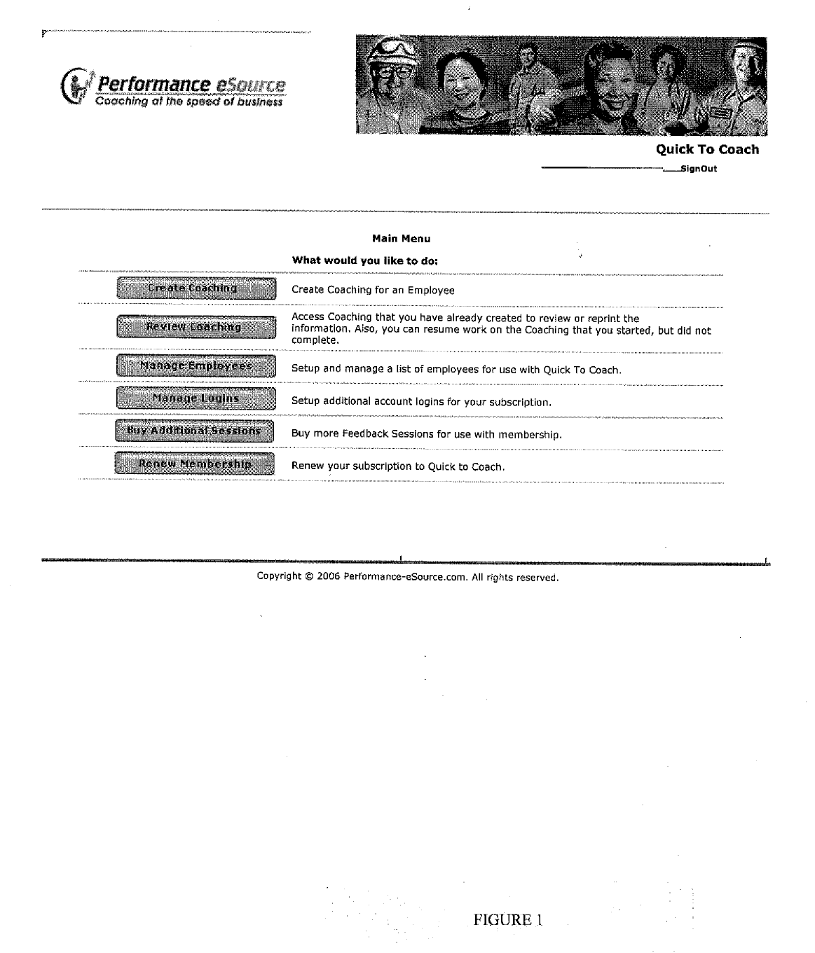

FIG. 1 an example screen shot of the main menu. The screen shot shows a menu of operations available at a computer interface from which a user selects a function to perform. The options minimally include, but are not limited to: (1) create coaching; (2) review and access coaching previously created; (3) select and manage a list of employees. Options to manage several accounts, buy access to the current invention, among others are other operations that may be available at this menu.

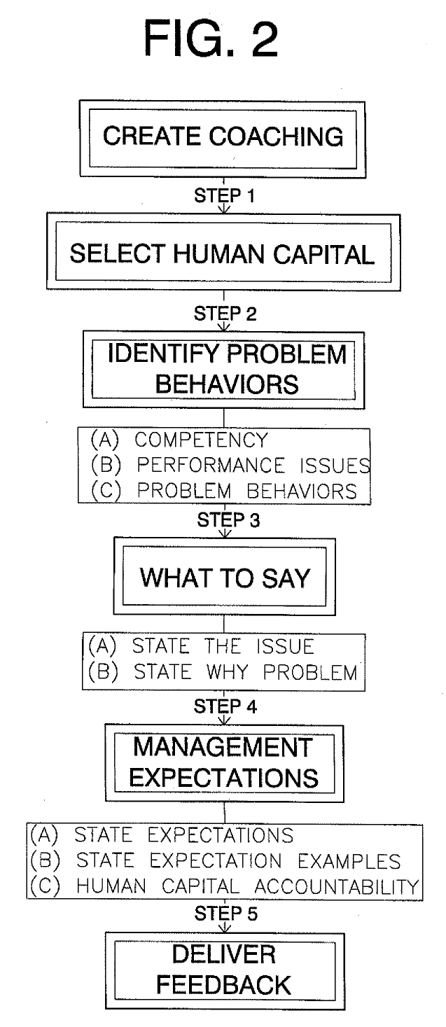

For illustration, it will be assumed that the user is not using the system for the first time. Accordingly, the database of employees has already been created. FIG. 2 is a flow chart of a selectable option “create coaching in the menu of FIG. 1.

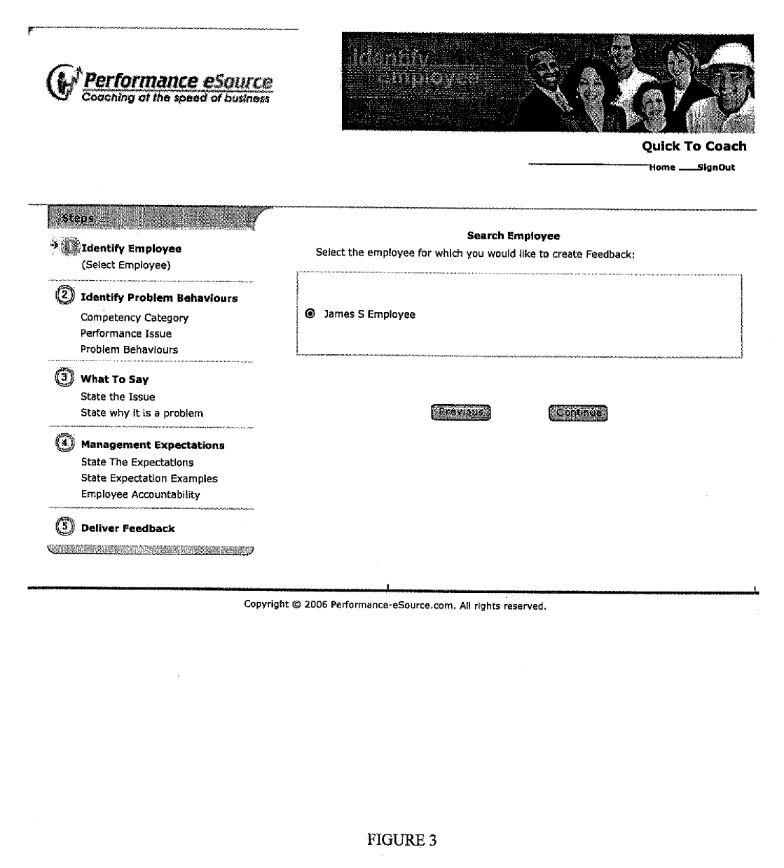

FIG. 3 is an example screen shot of Step 1, Select Human Capital, shown in FIG. 2. The user must choose from either a set of one or from a plurality of human capital listed. For exemplary purposes, the human capital chosen here is “James S. Employee”. The user can continue to the next screen or return to the menu of operation available at a computer interface.

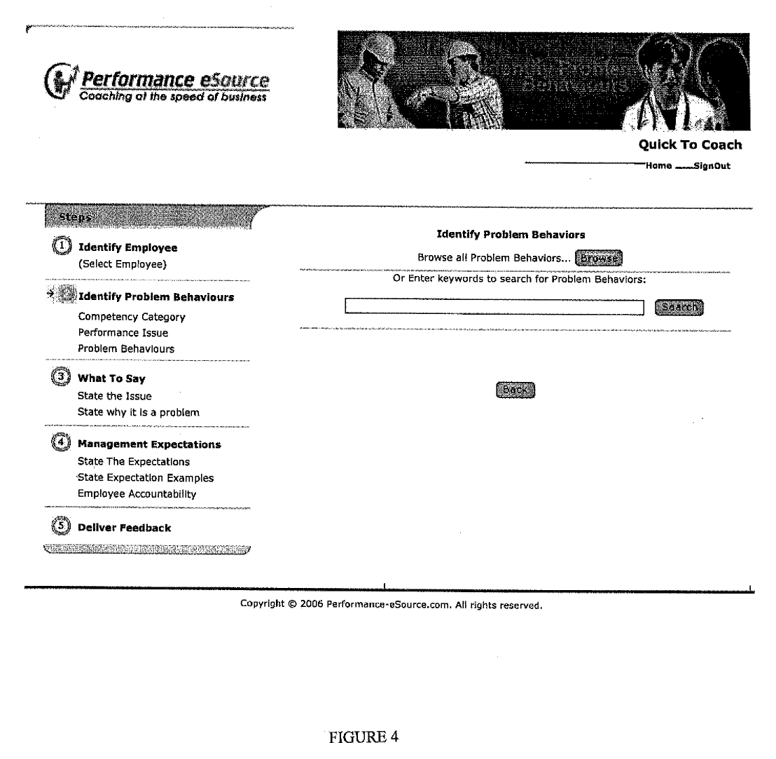

FIG. 4 is an example screen shot of Step 2, sub-part A, Competency, shown in FIG. 2. Because the user is often not able to isolate a behavior problem, the current invention allows the user to choose or describe a competency that is affected by the problem behavior. Competency refers to an individual's demonstrated knowledge, skills, or abilities (“KSAs”) performed to a specific standard. Competencies are observable, behavioral acts that require a combination of KSAs to execute.

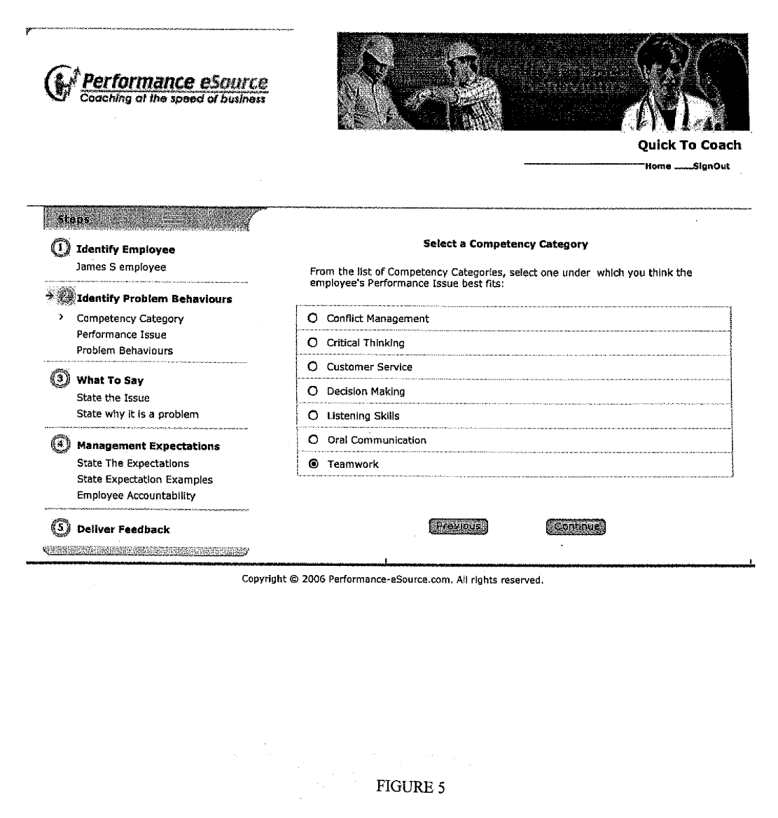

The user can either “browse” from a plurality of competencies or enter a keyword. FIG. 5 is an example screen shot of competencies that may be shown when the user browses problem behaviors. A similar list may appear when when a key word is entered. This is not an exhaustive list of the competencies.

The user must choose one competency issue from either a set of one or one from a plurality of issues listed. For exemplary purposes, the user here chooses “Teamwork”. If the user is not satisfied with his results, he can choose to go back to the previous screen to enter or choose a different problem behavior. If the user is satisfied with his selection, he can continue on to the next phase of the evaluation.

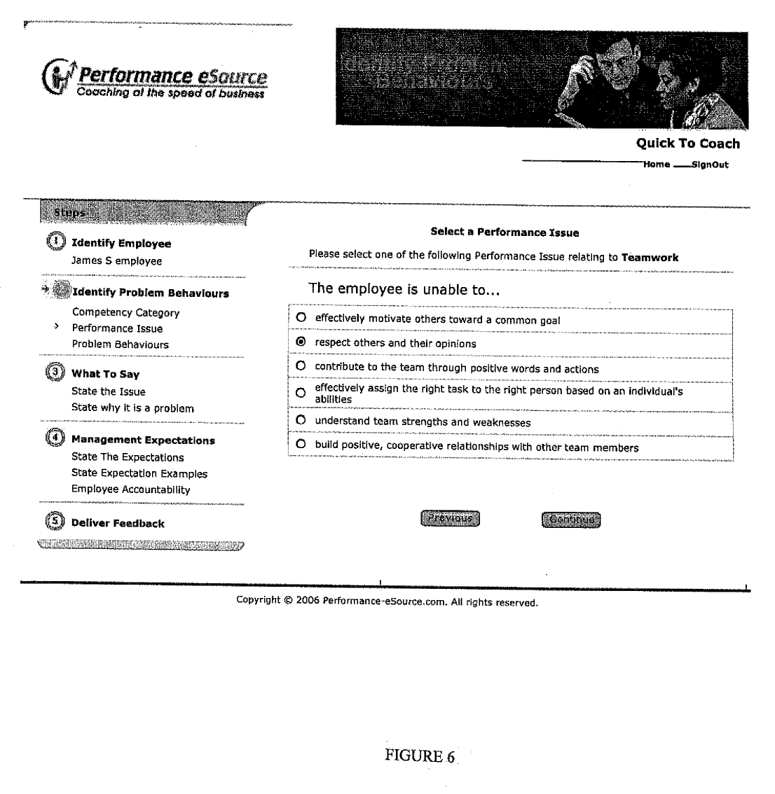

FIG. 6 is an example screen shot of Step 2, sub-part B, Performance Issues, shown in FIG. 2. The user is asked to further narrow the issue by choosing, from a plurality of choices, a performance issue. For exemplary purposes, the performance issue chosen is “respect others and their opinions”. If the user is not satisfied with his results, he can choose to go back to the previous screen to choose a different competency. If the user is satisfied with his selection, he can continue on to the next phase of the evaluation.

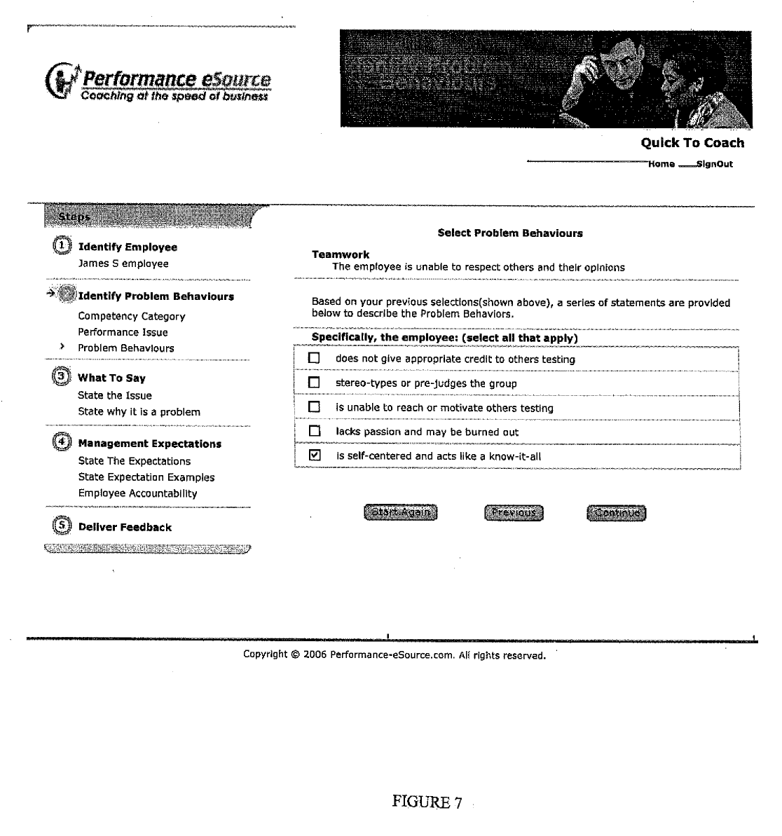

FIG. 7 is an example screen shot of Step 2, sub-part C, Problem Behaviors, shown in FIG. 2. The current invention lists either a set of one or a plurality of problem behaviors that is observable to the user. The user is required to select either one or a plurality of observed problem behaviors. For exemplary purposes “is self-centered and acts like a know it all” is chosen. If the user is not satisfied with his results, he can choose to go back to the previous screen to choose a different performance issue. If the user is satisfied with his selection, he can continue on to the next phase of the evaluation. If the user does not believe any of the choices available are relevant, he can also choose to start the process over. If the user chooses to continue, a quality assurance screen appears and the user is given the options to, minimally: (1) continue; (2) return to the previous screen; or (3) start the process again.

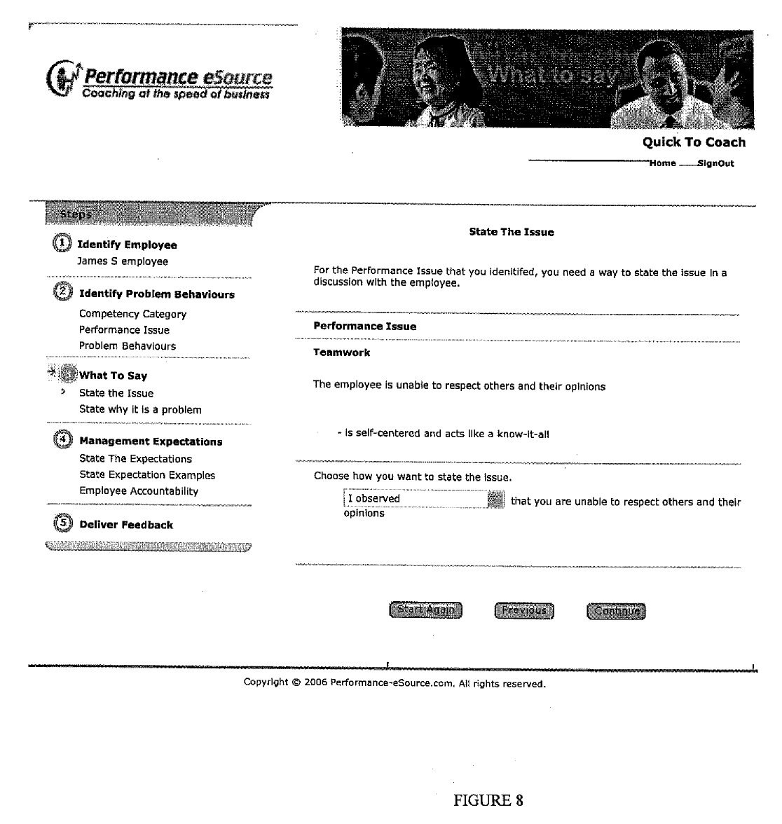

FIG. 8 is an example screen shot of Step 3, sub-part A, State the Issue, shown in FIG. 2. This function gives the user a script so that he can verbalize the issue. The user may choose from either a set of one or from a plurality of experience statements such as, but not limited to, “I observed.”, “I experienced . . . ”, or “I observed and experienced . . . ”, among others. For exemplary purposes, the “I observed” statement is chosen. If the user is not satisfied with his results, he can choose to go back to the previous screen to choose a different problem behavior. If the user is satisfied with his selection, he can continue on to the next phase of the evaluation. If the user does not believe any of the choices available are relevant, he can also choose to start the process over.

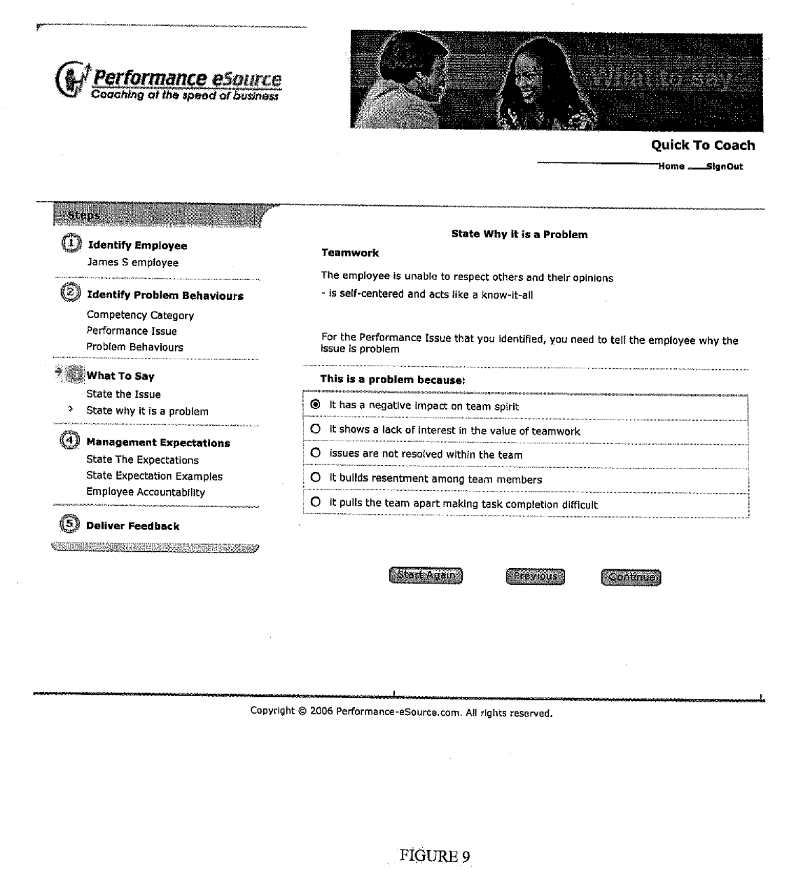

FIG. 9 is an example of a screen shot of Step 3, sub-part B, State Why it is a Problem, shown in FIG. 2. This step provides the user with a script so that he can verbalize the reason that the behavior is a problem. The user can choose from a set of one reason or from a plurality of reasons as to why a particular behavior is a problem. For exemplary purposes, the script chosen is: “This is a problem because it has a negative impact on team spirit.” If the user is not satisfied with his results, he can choose to go back to the previous screen to enter or choose a different problem behavior. If the user is satisfied with his selection, he can continue on to the next phase of the evaluation. If the user does not believe any of the choices available are relevant, he can also choose to start the process over.

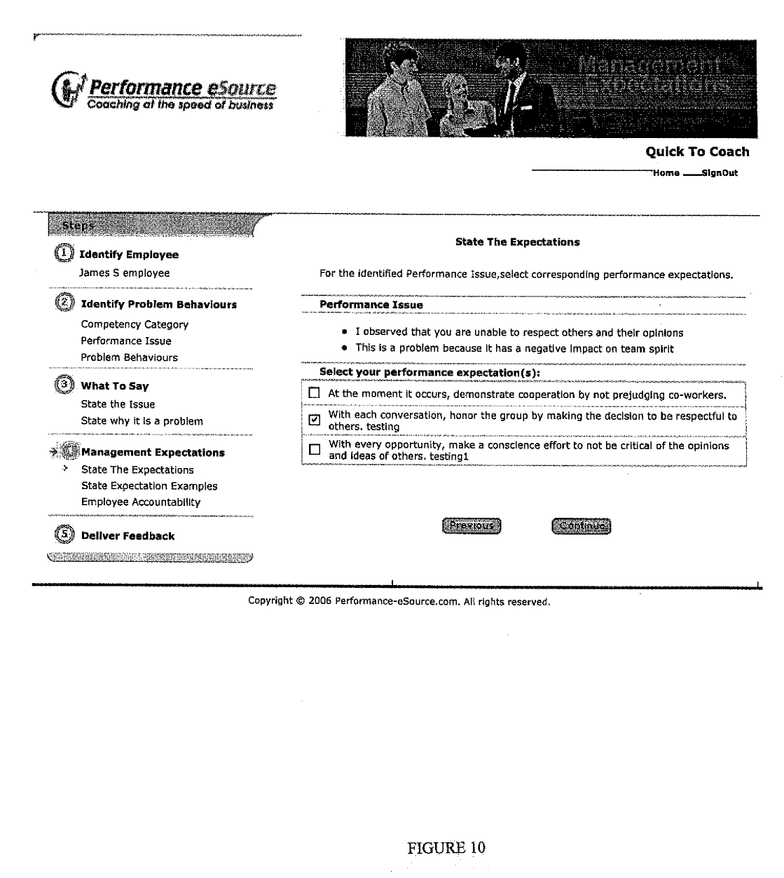

FIG. 10 is an example screen shot of Step 4, sub-part A, State

Expectations, shown in FIG. 2. This step provides the user with a script to verbalize expectations. The current invention lists either a set of one or a plurality of expectations. The user is required to select either one expectation or a plurality of expectations. For exemplary purposes the performance expectation chosen is: “With each conversation, honor the group by making the decision to be respectful to others.” If the user is not satisfied with his results, he can choose to go back to the previous screen to choose a different problem statement. If the user is satisfied with his selection, he can continue on to the next phase of the evaluation.

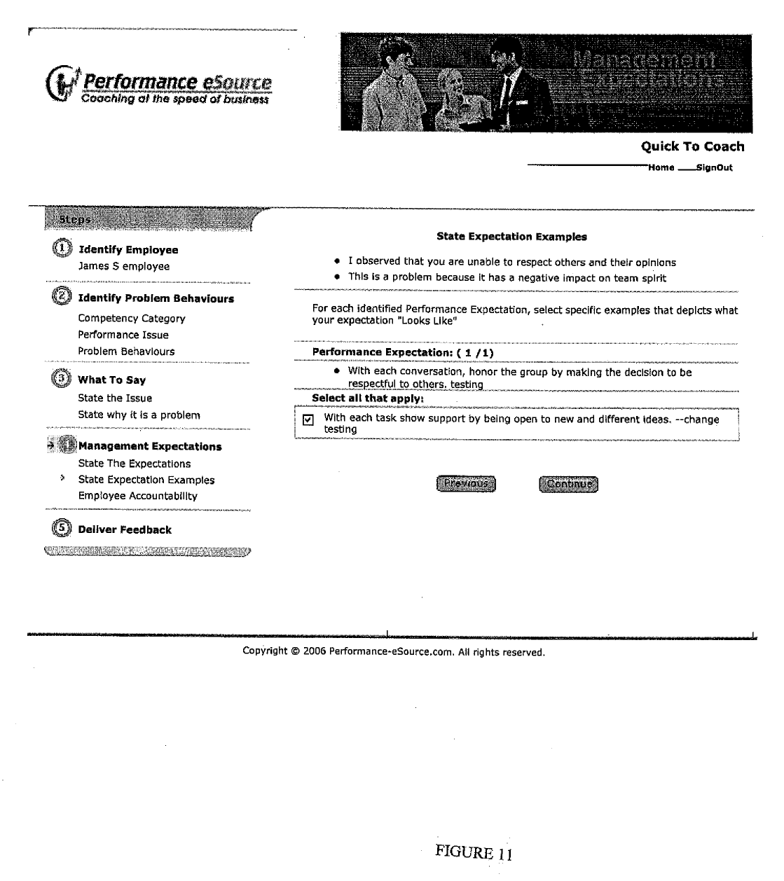

FIG. 11 is an example screen shot of Step 4, sub-part B, State Expectation Examples, shown FIG. 2. This step provides the user with, minimally: (1) a measurable performance expectation; and (2) either one or a plurality of situations where performance expectations can be measured. For exemplary purposes the following example is chosen: “With each task show support by being open to new and different ideas”. If a plurality of performance expectations were chosen in this step, then the user would step through a series of: (1) measurable performance expectations; and (2) either of one or a plurality of situations where performance expectations can me measured. If the user is not satisfied with his results, he can choose to go back to the previous screen to enter or choose different expectations. If the user is satisfied with his selection, he can continue on to the next phase of the evaluation.

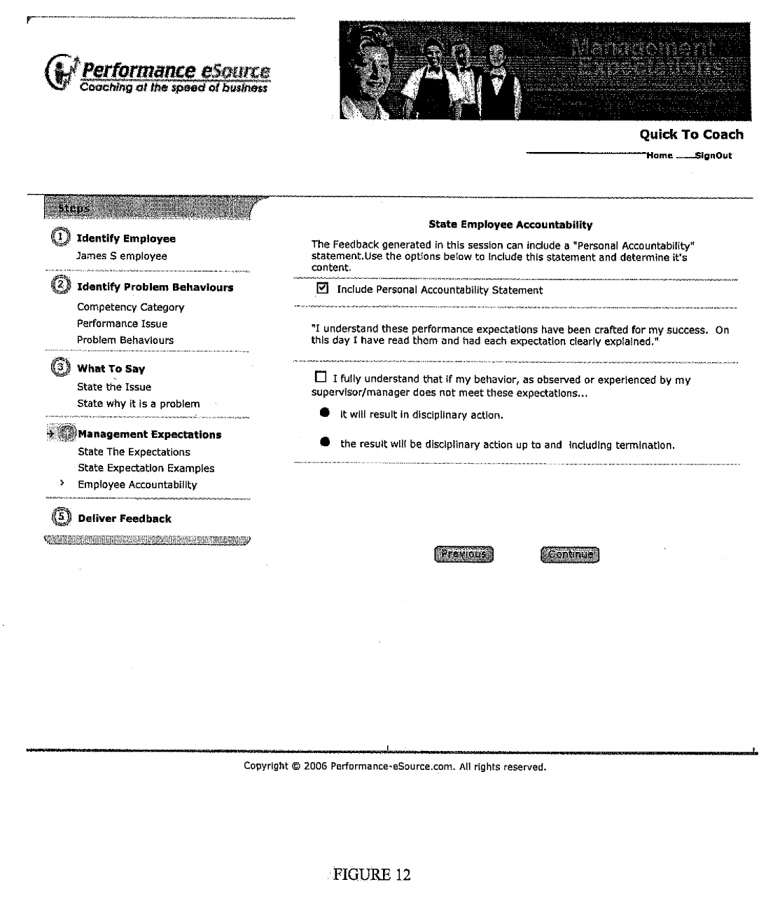

FIG. 12 is an example a screen shot of Step 4, sub-part C, Human Capital Accountability, shown in FIG. 2. This step allows the user to generate “feedback” for the human capital by means of a “Personal Accountability” statement. The user can choose either a personal accountability statement or a general accountability statement which provides documentation for the human capital. If the user is not satisfied with his results, he can choose to go back to the previous screen to choose a different expectation. If the user is satisfied with his selection, he can continue on to the next phase.

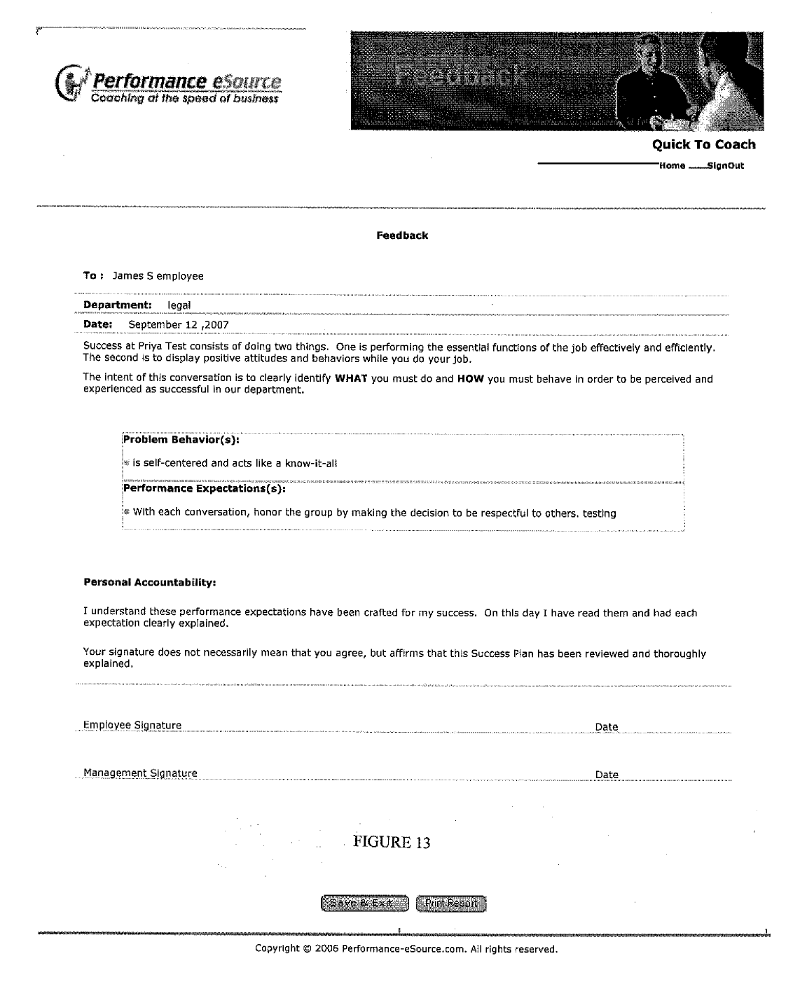

FIG. 13 is an example screen shot of Step 5 shown in FIG. 2, Feedback. The user can save the process and exit the invention and/or print the feedback.

In view of the above it will be seen that various aspects and features of the invention are achieved and other results and advantages attained. While preferred embodiments of the invention have been shown and described, it will be obvious to those skilled in the art that changes and modification may be made therein without departing from the invention in its broader aspects.

What is claimed is:

1. A method for utilizing a computer system to instruct a user on how to articulate and move towards correcting problem behaviors exhibited by human capital and set quantifiable expectations towards resolving said problem behaviors, said method comprising the steps of:
a. identifying problem behaviors
b. creating a dialogue for the manager
c. creating a quantifiable expectation;

2. the method of claim 1 wherein the step of identifying problem behaviors further comprises of the steps of:
a. determining competency that is affected by problem behavior;
b. determining the performance issues that result from problem behavior;
c. determining the problem behavior;

3. the method of claim 1 wherein the step of creating a dialogue for the user further comprises of the steps of:
a. creating a script giving user the ability to verbalize at least, but not limited to, observed, experienced, or observed and experienced behavior issue, among others;
b. creating a script giving the user the ability to verbalize why the problem behavior is detrimental to other human capital, the business, the project, morale, among others;

4. the method of claim 1 wherein the step of identifying management expectations further comprises the steps of:
a. choosing at least one expectation from a set of either one expectation or from a plurality of expectations;
b. quantifying performance expectation;
c. choosing at least one example from a set of either one example or a plurality of examples as circumstances in which quantified performance expectations can be measured;

5. the method of claim 1 wherein the method further comprises the step of allowing the user to choose a personal accountability statement;

6. the method of claim 1 wherein the method further comprises the step of allowing the user to choose a general accountability statement for the human capital;

7. the method of claim 1 wherein the method further comprises the step of providing feedback for the human capital.
